(19) United States
(12) Patent Application Publication
(10) Pub. No.: US 2009/0194399 A1
(43) Pub. Date: Aug. 6, 2009

(54) PRESSURE SWITCH STRUCTURE

(76) Inventor: Chan-Ching LIN, Da Du Village (TW)

Correspondence Address: RABIN & Berdo, PC, 1101 14TH STREET, NW, SUITE 500, WASHINGTON, DC, 20005, US

(21) Appl. No.: 12/023,378

(22) Filed: Jan. 31, 2008

(51) Int. Cl. H01H 9/04

(52) U.S. Cl. 200/302.1

(57) ABSTRACT

In an improved pressure switch structure, a metal casing is provided for sealing and covering the exterior of the pressure switch, such that a wire contact point at an end of the pressure switch is sealed and protected from moisture, and a plug cap in a wire through hole of the metal casing is provided for wrapping and binding a power supply wire to achieve a fixed positioning effect, so that the power supply wire will not be pulled or loosened easily and is sealed and protected from moisture and dust.

### BACKGROUND OF THE INVENTION

1. Field of the Invention

The present invention relates to an improved pressure switch structure comprising a metal casing for sealing and covering a pressure switch, a plug cap disposed in a wire through hole of the metal casing for wrapping and binding a power supply wire to constitute a fixed positioning effect, so that a wire contact point at an end of the pressure switch is protected from moisture and dust, and prevented from being pulled or loosened easily.

2. Description of the Related Art

In general, a pressure switch is generally installed at a position of a car or an air compressor as shown in FIGS. 1A and 1B. After an end of the pressure switch A is connected to a power supply wire B, a rubber cover C is installed to fix the pressure switch A, and a binder D is provided for binding the power supply wire B. However, the external surface of the rubber cover C installed at the pressure switch A may be aged and deteriorated by factors such as high temperature and moisture, and contact points of the pressure switch A and the power supply wire B may be rusted by moisture, and the power supply wire B simply tied by the binder D may be pulled easily, and thus the power supply wire B will be loosened easily.

### SUMMARY OF THE INVENTION

Therefore, it is a primary objective of the present invention to provide an improved pressure switch structure to overcome the shortcomings of the prior art, wherein the structure comprises a metal casing for sealing and covering the exterior of the pressure switch, such that a wire contact point at an end of the pressure switch is sealed and protected from moisture and dust.

Another objective of the present invention is to provide an improved pressure switch structure comprising a plug cap in a wire through hole of the metal casing for wrapping and binding a power supply wire to achieve a fixed positioning effect, so that the power supply wire will not be pulled or loosened easily.

### BRIEF DESCRIPTION OF THE DRAWINGS

FIG. 1A is a schematic view of an installation position of a prior art;

FIG. 1B is a schematic view of a structure of a prior art;

FIG. 2A is an exploded view of the present invention;

FIG. 2B is a schematic view of an assembly of the present invention;

FIG. 2C is a schematic view of a sealed assembly of the present invention;

FIG. 3 is a perspective view of the present invention;

FIG. 4A is a schematic view of the present invention with a different configuration; and

FIG. 4B is a perspective view of the present invention with a different configuration.

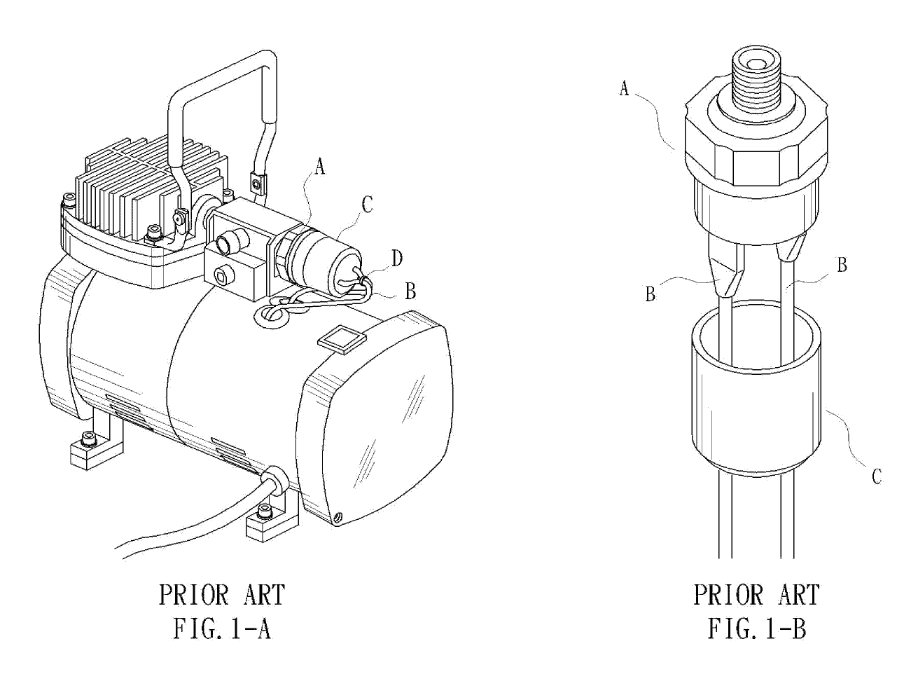

### DETAILED DESCRIPTION OF THE PREFERRED EMBODIMENTS

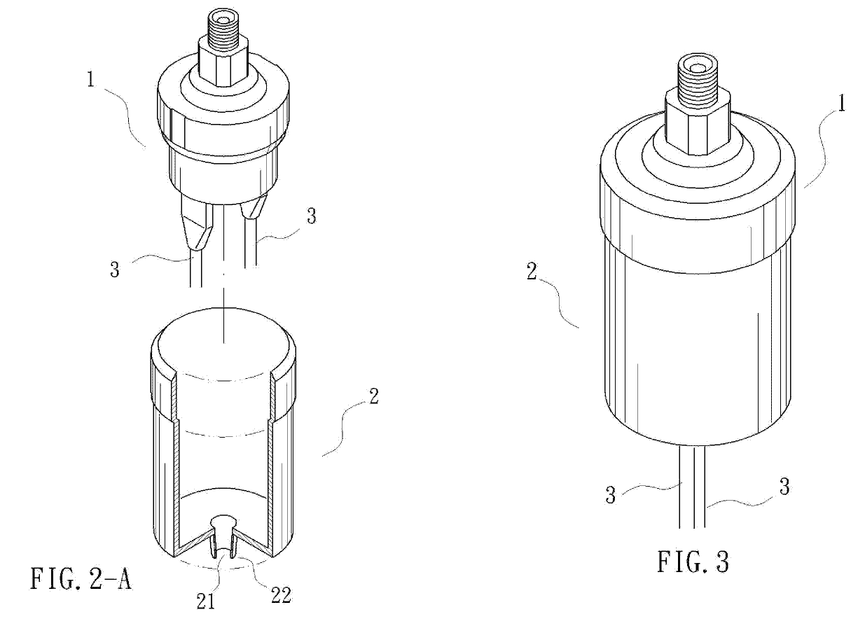

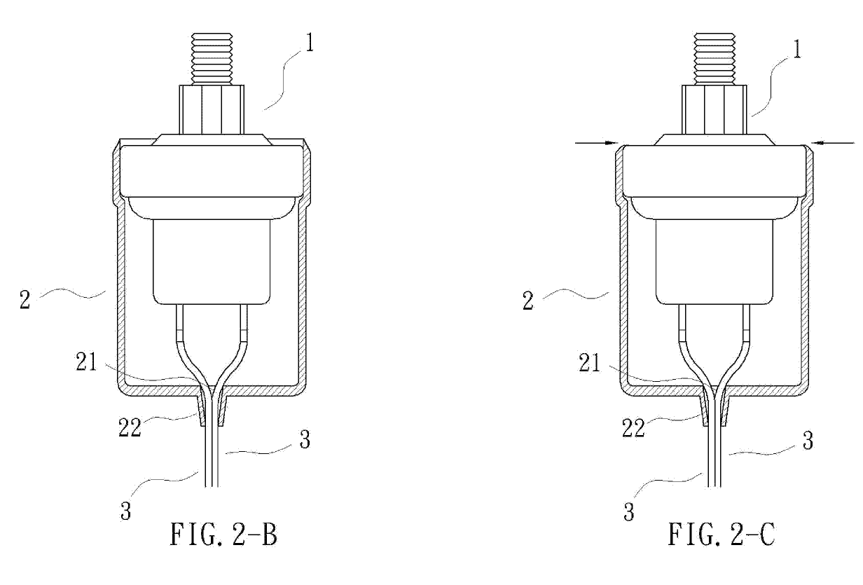

In FIGS. 2A, 2B, 2C and 3, the present invention provides an improved pressure switch structure, comprising a metal casing 2 integrated with an external surface of a distal end of the pressure switch 1, and manufactured to completely seal and cover the distal end of the pressure switch 1 as shown in FIGS. 2C and 3. Since the distal end of the pressure switch 1 is covered by the metal casing 2, therefore a wire contact point at the distal end of the pressure switch 1 will not be moistened easily. Further, a plug cap 22 is integrally formed in a wire through hole 21 of the metal casing 2 and provided for wrapping and binding the power supply wire 3 to constitute a fixed positioning effect as shown in FIGS. 2B and 2-C, so that the power supply wire 3 will not be pulled or loosened easily.

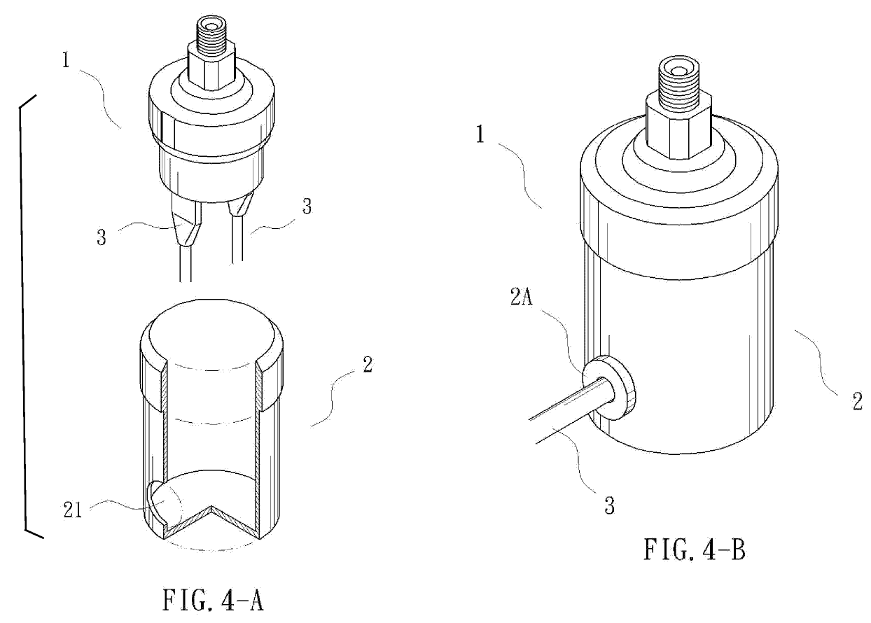

To take the adaptability to the environment into consideration, the invention further provides a plug cap 2A integrated with the wire through hole 21 of the metal casing 2 for wrapping and binding the power supply wire 3 to constitute a fixed positioning effect as shown in FIGS. 4B and 4-C, such that the power supply wire 3 will not be pulled or loosened easily.

In summation of the description above, the present invention improves over the prior art, and complies with the requirements of patent application, and thus is duly filed for patent application.

What is claimed is:

1. An improved pressure switch structure, comprising a metal casing, for sealing and covering the exterior of a pressure switch, such that an end of the sealed pressure switch is protected to achieve the effects of resisting moisture and dust.

2. The improved pressure switch structure of claim 1, further comprising a plug cap disposed at a wire through hole of the metal casing for wrapping and binding the power supply wire to achieve a fixed positioning effect, such that the power supply wire will not be pulled or loosened easily.
